(19) United States
(12) Patent Application Publication
(10) Pub. No.: US 2019/0272854 A1
(43) Pub. Date: Sep. 5, 2019

(54) HARD DISK DRIVE VIBRATION-PROOF STRUCTURE

(71) Applicant: GETAC TECHNOLOGY CORPORATION, Hsinchu County (TW)

(72) Inventor: Wei-Ting YU, Taipei City (TW)

(21) Appl. No.: 16/032,001

(22) Filed: Jul. 10, 2018

(30) Foreign Application Priority Data
Mar. 2, 2018 (CN) 201810173223.6

(51) Int. Cl. G11B 33/08; G11B 33/02

(52) U.S. Cl. CPC G11B 33/08; G11B 33/025

(57) ABSTRACT

A hard disk drive vibration-proof structure includes a casing and a buffer element for suspending a hard disk drive in the casing to render the hard disk drive vibration-proof. The buffer element encloses the hard disk drive and is disposed in the casing. The hard disk drive is suspended in the casing by the buffer element. Therefore, the hard disk drive vibration-proof structure achieves suspended antivibration which features enhanced efficiency of antivibration, and, in particular, achieves suspended antivibration with a simple structure.

### CROSS-REFERENCE TO RELATED APPLICATIONS

This application claims priority from China Patent Application No. 201810173223.6, filed on Mar. 2, 2018, the entire disclosure of which is hereby incorporated by reference.

### BACKGROUND OF THE INVENTION

### Field of the Invention

The present invention relates to the antivibration of hard disk drives and, more particularly, to a suspended hard disk drive vibration-proof structure.

### Description of the Prior Art

A conventional hard disk drive vibration-proof structure works by fixing a hard disk drive in place inside a casing and then filling sponge in the space between each outer side of the hard disk drive and a corresponding one of inner sides of the casing, so as to effectuate antivibration.

However, the antivibration function thus performed is so inefficient that error correction can be carried out only by trial and error. As a result, the prior art has admittedly notorious drawbacks: time-consuming, laborious, and structurally complicated.

Therefore, the inventor of the present invention aims to design a hard disk drive vibration-proof structure that overcomes the aforesaid drawbacks of the prior art.

### SUMMARY OF THE INVENTION

It is an objective of the present invention to provide a hard disk drive vibration-proof structure that is suspended and thereby rendered vibration-proof.

In order to achieve the above and other objectives, the present invention provides a hard disk drive vibration-proof structure which comprises a casing and a buffer element enclosing the hard disk drive and disposed in the casing. The hard disk drive is suspended in the casing by the buffer element.

Compared with the prior art, the present invention has advantages as follows: achieving suspended antivibration which features enhanced efficiency of antivibration, and, in particular, achieving suspended antivibration with a simple structure in a time-efficient, labor-saving and cost-efficient manner.

### BRIEF DESCRIPTION OF THE DRAWINGS

FIG. 1 is a general perspective exploded view of a hard disk drive vibration-proof structure according to the first embodiment of the present invention;

FIG. 2 is a detailed exploded view of the hard disk drive vibration-proof structure of FIG. 1 according to the present invention;

FIG. 3 is a lateral view of a stand of the hard disk drive vibration-proof structure according to the first embodiment of the present invention;

FIG. 4 is a partial cross-sectional view of the hard disk drive suspended in a casing and thereby rendered vibration-proof according to the first embodiment of the present invention;

FIG. 5 is a partial enlarged view of FIG. 4 according to the present invention;

FIG. 6 is an exploded view of the hard disk drive vibration-proof structure according to the second embodiment of the present invention; and

FIG. 7 is a cross-sectional view of the assembled hard disk drive vibration-proof structure of FIG. 6 according to the present invention.

### DETAILED DESCRIPTION OF THE EMBODIMENTS

The technical features of the present invention are described hereunder with reference to the accompanying drawings. However, the accompanying drawings are for reference and illustration only rather than restrictive of the present invention.

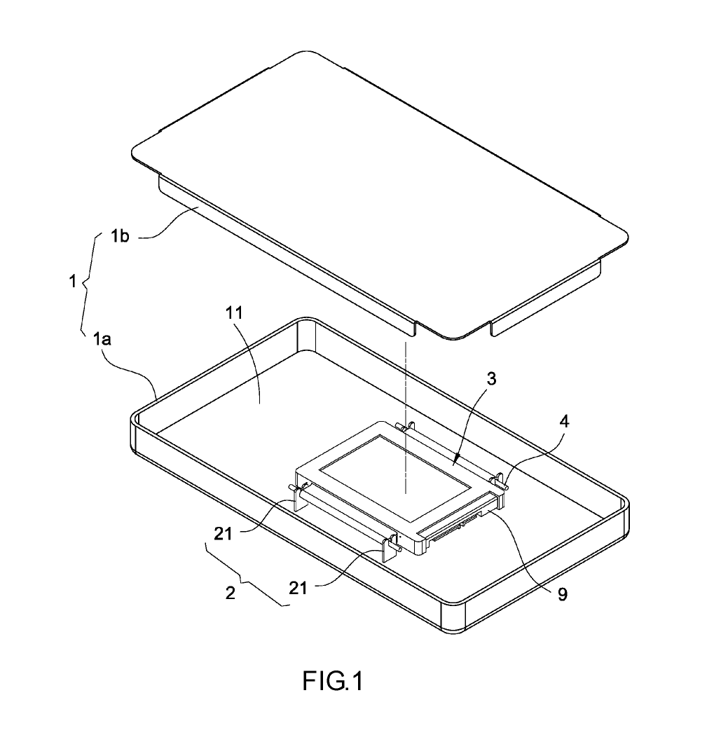

Referring to FIG. 1, the present invention provides a hard disk drive vibration-proof structure mainly adapted to suspend a data storage device in a casing 1 by a buffer element 3 to achieve suspended antivibration. The data storage device can be any machine capable of data storage. In this embodiment, the data storage device is exemplified by a hard disk drive (HDD) 9. The casing 1 is a casing for a removable hard disk drive, a casing for a portable hard disk drive, a casing for an external hard disk drive, or even a casing for any electronic device (for example, a notebook or a tablet) which must be equipped with the hard disk drive 9, but the present invention is not limited thereto.

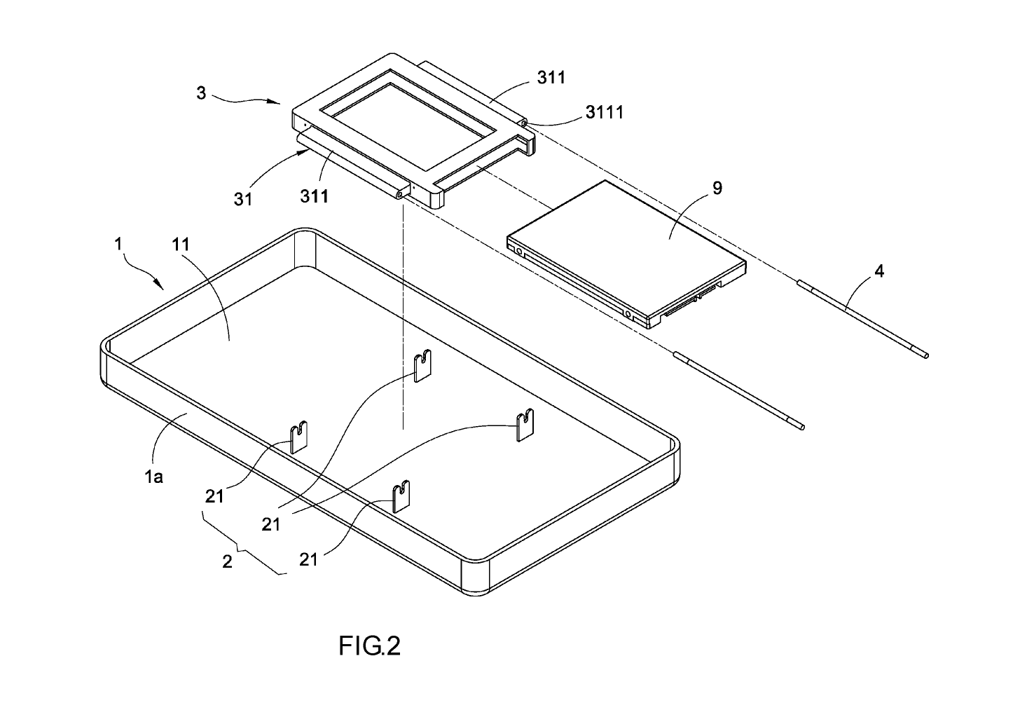

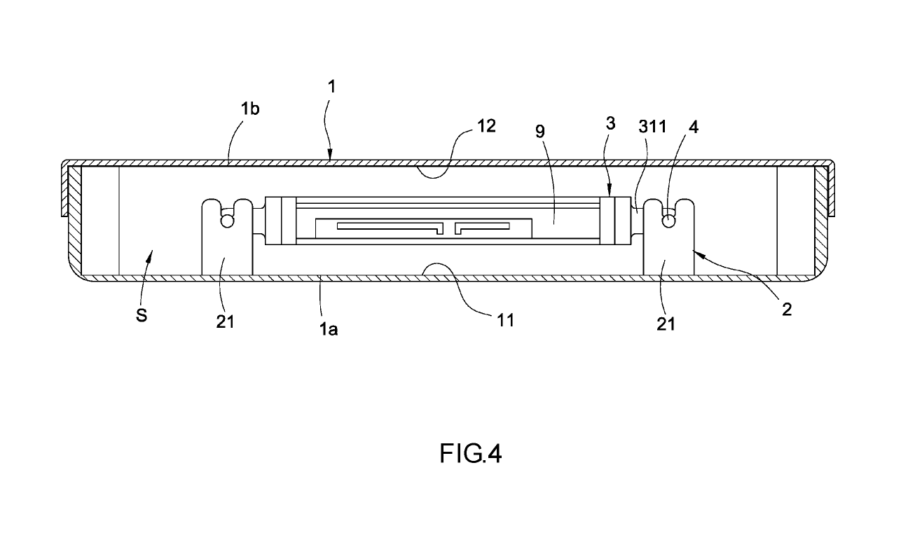

Referring to FIG. 1, FIG. 2 and FIG. 4, there are shown diagrams of a hard disk drive vibration-proof structure according to the first embodiment of the present invention. As shown in the diagrams, the hard disk drive vibration-proof structure comprises the casing 1 and the buffer element 3 and, preferably, further comprises a support element 2 and hanging rods 4.

The casing 1 is one-piece (not shown) or multi-piece. The casing 1 in the first embodiment is exemplified by a multi-piece casing. The multi-piece casing 1 comprises a first case 1a and a second case 1b which fit together. The first case 1a and the second case 1b have an inner wall 11 and an inner wall 12, respectively. After fitting together, the first case 1a and the second case 1b form a receiving space S (shown in FIG. 4) therebetween.

The buffer element 3 is made of a material capable of buffering, such as rubber, silica gel or sponge, but the present invention is not limited thereto. The first embodiment is exemplified by rubber.

The buffer element 3 encloses the hard disk drive 9. The hard disk drive 9 enclosed by the buffer element 3 is disposed in the casing 1, that is, disposed in the receiving space S. The hard disk drive 9 is suspended in the receiving space S of the casing 1 by the buffer element 3. If the casing 1 is, for example, hit and thus vibrates, shock arising from the vibration will be absorbed by the buffer element 3 disposed between the hard disk drive 9 and the casing 1, thereby achieving suspended antivibration. In a variant embodiment not shown, the buffer element 3 encloses the hard disk drive 9 or is coupled thereto.

The support element 2, which serves a supportive purpose, is disposed in the casing 1. The buffer element 3 is supportedly disposed on the support element 2 such that the support element 2 is supported between the buffer element 3 and the inner wall 11 (or 12) of the casing 1, thereby allowing the hard disk drive 9 to be suspended in the receiving space S of the casing 1 and thus rendered vibration-proof.

Referring to FIG. 1 and FIG. 2, the support element 2 comprises two opposite stand rows (not denoted by any reference numeral). The two stand rows each have stands 21 which are spaced apart. The stands 21 are each disposed upright on any inner wall of the casing 1. The first embodiment is exemplified by the stands 21 disposed upright on the inner wall 11 of the first case 1a. The buffer element 3 forms, at an appropriate point thereof, an extender 31. The present invention is not restrictive of the location of the extender 31 on buffer element 3. In the first embodiment, the extender 31 is formed on two opposing sides of the buffer element 3. The extender 31 comprises two elastic arms 311 formed on two opposing sides of the buffer element 3, respectively. The elastic arms 311 are supportedly disposed between the stands 21 of the stand rows, respectively; hence, the buffer element 3 can be supportedly disposed on the stands 21 because of the extender 31 such that the hard disk drive 9 is suspended in the receiving space S of the casing 1 by the buffer element 3 to achieve suspended antivibration.

In another variant embodiment not shown, the support element 2 comprises circular said stands 21 which are spaced apart and disposed upright on the inner wall 11 of the first case 1a. Circular said extender 31 is formed on lateral sides of the buffer element 3 to allow the buffer element 3 to be supportedly disposed on the stands 21; hence, the hard disk drive 9 is suspended in the receiving space S of the casing 1 by the buffer element 3 to achieve suspended antivibration.

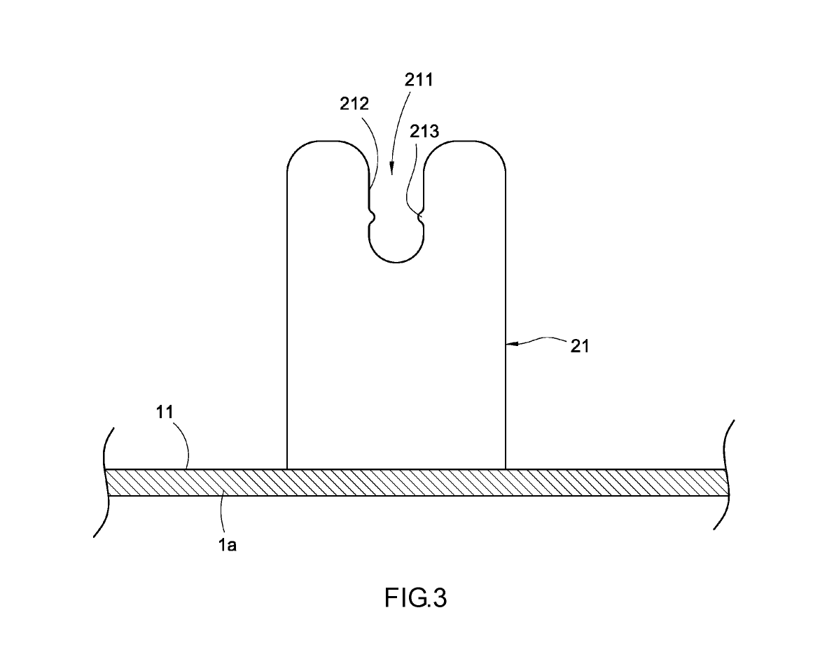

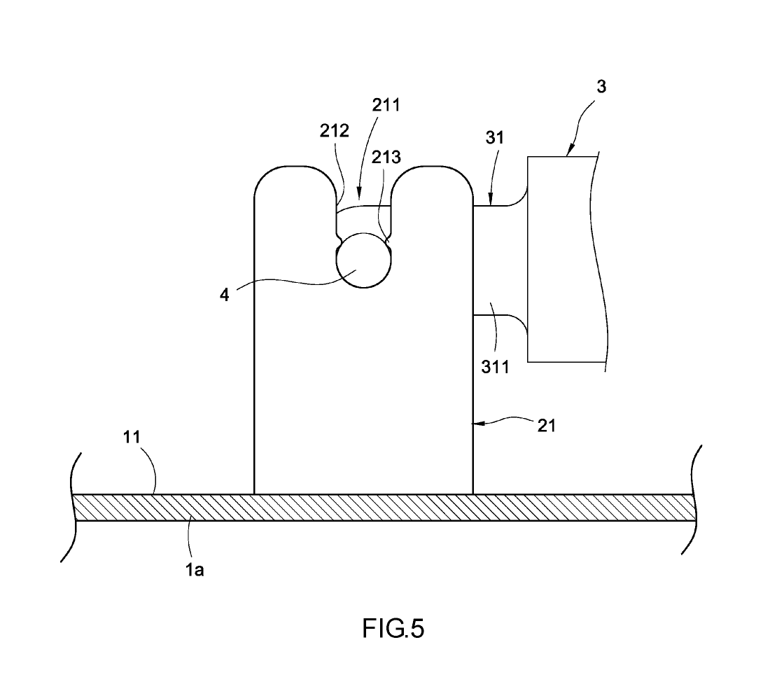

The buffer element 3 is hung on the support element 2 by the hanging rods 4. The hanging rods 4 are penetratingly disposed in the elastic arms 311 and supportedly disposed on the stands 21 of the stand rows, respectively, as shown in FIG. 1. The present invention is not restrictive of the mechanism whereby the hanging rods 4 are penetratingly disposed in the elastic arms 311. In the first embodiment, the elastic arms 311 each have a through hole 3111 (shown in FIG. 2) formed in the lengthwise or widthwise direction of the buffer element 3, and the through holes 3111 allow the hanging rods 4 to be penetratingly disposed in the elastic arms 311, respectively. The present invention is not restrictive of the mechanism whereby the hanging rods 4 are supportedly disposed on the stands 21. In the first embodiment illustrated by FIG. 3 and FIG. 5, the stands 21 each have a slot 211 which opens downward, and the hanging rods 4 are received by the slots 211 and thus hung on the stands 21, respectively.

Referring to FIG. 3 and FIG. 5, blockers 213 are protrudingly disposed at an inner edge 212 of the slot 211 of each said stand 21 such that the hanging rods 4 received by the slots 211 are blocked by the blockers 213 to prevent detachment of the hanging rods 4 from the slots 211. Hence, detachment of the hanging rods 4 may occur only under a sufficiently great external force.

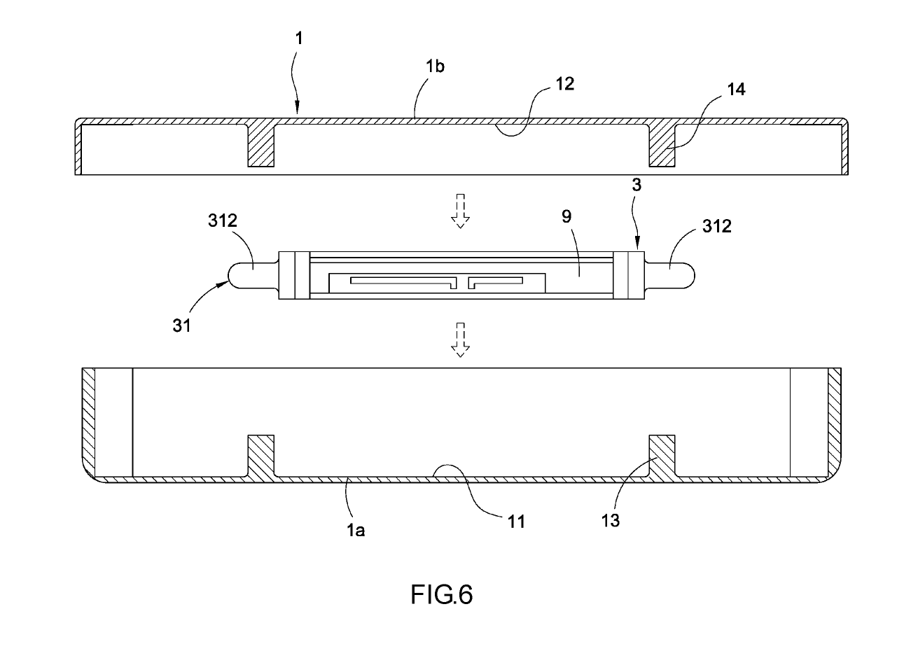

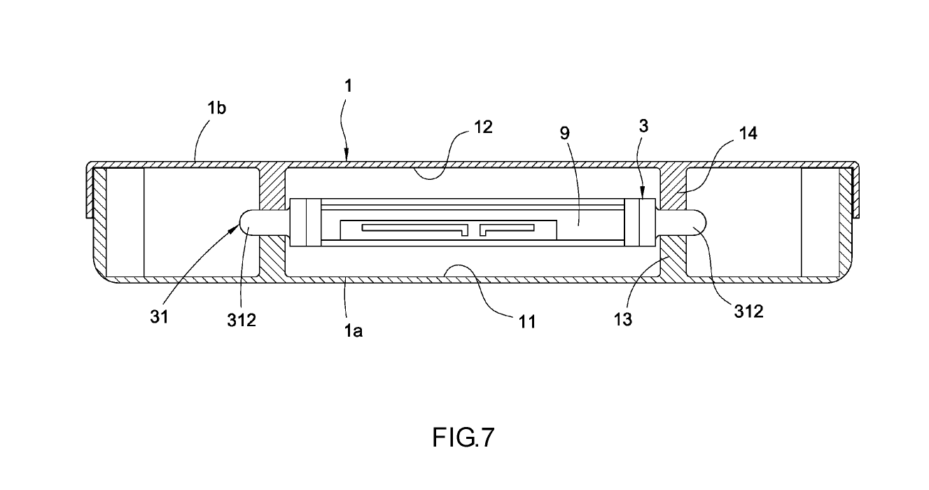

Referring to FIG. 6 and FIG. 7, there are shown diagrams of the hard disk drive vibration-proof structure according to the second embodiment of the present invention. As shown in the diagrams, the second embodiment is substantially the same as the first embodiment except that first and second supporters 13, 14 substitute for the support element 2 and the hanging rods 4, as described later.

The first supporter 13 and the second supporter 14 are protrudingly disposed on the first case 1a and the second case 1b, respectively. The first supporter 13 and the second supporter 14 point at each other to clamp the extender 31 of the buffer element 3 from two opposing sides, respectively, such that the hard disk drive 9 is suspended in the casing 1 by the buffer element 3 to achieve suspended antivibration.

The first supporter 13 and the second supporter 14 are circular supportive walls (not shown) or opposite supportive walls (shown in FIG. 6 and FIG. 7), but the present invention is not limited thereto. The present invention does not require that the extender 31 formed around the buffer element 3 must be circular (not shown) or opposite (shown in FIG. 6 and FIG. 7). According to the present invention, the extender 31 can be of any shape, provided that the extender 31 is clamped by the first and second supporters 13, 14 from two opposing sides, respectively.

Referring to FIG. 6 and FIG. 7, two opposing first supporters 13 are protrudingly disposed on the inner wall 11 of the first case 1a, and two opposing second supporters 14 are protrudingly disposed on the inner wall 12 of the second case 1b. The extender 31 comprises two elastic arms 312 formed on two opposing sides of the buffer element 3, respectively, and extending oppositely. The two elastic arms 312 are clamped between two first supporters 13 and two second supporters 14 and thereby suspended. The elastic arms 312 extend away from the lateral sides of the buffer element 3, respectively, in a manner that the elastic arms 312 are formed integrally with the buffer element 3.

In conclusion, compared with the prior art, the present invention has advantages as follows: achieving suspended antivibration which features enhanced efficiency of antivibration, and, in particular, achieving suspended antivibration with the aforesaid simple structure in a time-efficient, labor-saving and cost-efficient manner.

Although the present invention is disclosed above by preferred embodiments, the preferred embodiments are not restrictive of the claims of the present invention. Equivalent structural changes made to the preferred embodiments with reference to the specification and drawings of the present invention must be deemed falling within the scope of the present invention.

What is claimed is:

1. A hard disk drive vibration-proof structure, comprising:
a casing; and
a buffer element enclosing the hard disk drive and disposed in the casing,
wherein the hard disk drive is suspended in the casing by the buffer element.

2. The hard disk drive vibration-proof structure according to claim 1, wherein the casing has therein a support element supported between the buffer element and an inner wall of the casing, and the buffer element is supportedly disposed on the support element.

3. The hard disk drive vibration-proof structure according to claim 2, wherein the buffer element forms an extender whereby the buffer element is supportedly disposed on the support element.

4. The hard disk drive vibration-proof structure according to claim 2, wherein the support element comprises stands disposed on the inner wall, and the buffer element is supportedly disposed on the stands.

5. The hard disk drive vibration-proof structure according to claim 4, wherein the buffer element forms an extender whereby the buffer element is supportedly disposed on the stands.

6. The hard disk drive vibration-proof structure according to claim 5, wherein the extender comprises at least two elastic arms each supportedly disposed between at least two said stands.

7. The hard disk drive vibration-proof structure according to claim 5, further comprising at least two hanging rods penetratingly disposed in at least two elastic arms of the extender, respectively, and supportedly disposed between at least two said stands.

8. The hard disk drive vibration-proof structure according to claim 7, wherein the stands each have a slot, and the hanging rods are received by the slots of at least two said stands, respectively.

9. The hard disk drive vibration-proof structure according to claim 8, wherein blockers are protrudingly disposed at an inner edge of the slot of each said stand such that the blockers of the stands block the hanging rods.

10. The hard disk drive vibration-proof structure according to claim 1, wherein the casing comprises a first case and a second case which fit together, with a first supporter protrudingly disposed on an inner wall of the first case, and a second supporter protrudingly disposed on an inner wall of the second case, allowing the buffer element to be clamped by the first supporter and the second supporter from two opposing sides, respectively, and thereby suspended in the casing.

11. The hard disk drive vibration-proof structure according to claim 10, wherein the first supporter and the second supporter are circular supportive walls.

12. The hard disk drive vibration-proof structure according to claim 10, wherein the buffer element forms an extender which the first supporter and the second supporter clamp from two opposing sides, respectively.

13. The hard disk drive vibration-proof structure according to claim 12, wherein the extender extends integrally away from lateral sides of the buffer element, respectively.
